(19) United States
(12) Patent Application Publication
(10) Pub. No.: US 2008/0193758 A1
(43) Pub. Date: Aug. 14, 2008

(54) Nanoscale Fluorescent Melamine Particles

(76) Inventors: Armin Kuebelbeck, Bensheim (DE); Juliane Riedel, Koeln (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/914,045

(22) PCT Filed: Apr. 20, 2006
(86) PCT No.: PCT/EP2006/003598

§ 371 Date: Nov. 9, 2007

(30) Foreign Application Priority Data
May 10, 2005 (DE) 10 2005 022 370.2

(51) Int. Cl. C08G 12/32; C08J 3/12; C08G 12/40; C09K 11/02; C08G 12/06

(52) U.S. Cl. 428/402; 428/690; 528/269

(57) ABSTRACT

The invention relates to nanoscale melamine-formaldehyde particles which have a particle diameter of 10 to 95 nm and comprise fluorescent dyes, to a process for the production thereof, and to the use thereof as support material for the preparation of biomarkers, ink-jet inks, fluorescent markers and/or as adsorption material for chromatographic separations.

The invention relates to nanoscale melamine-formaldehyde particles (MF particles) having a particle diameter of 10 to 95 nm, which may comprise fluorescent dyes and are preferably monodisperse, and to a process for the production thereof.

Fluorescent substances have numerous applications, especially in bio-chemistry. A fluorescent chemical group can be attached to biomolecules by a chemical reaction and then serves as very sensitive label for this molecule. In immunology, antibodies are provided with a fluorescent chemical group, meaning that the sites to which the antibodies bind are recognisable from the fluorescence. It is even possible for the antigen concentration to be determined quantitatively therewith. Fluorescent labels enable different bio-molecules to be detected in a cell. The labels fluoresce in different colours, and the fluorescence distribution, for example in tissue, can thus be observed under the fluorescence microscope.

The object of the present invention was to produce fluorescence-labelled nanoparticles having the smallest possible diameter (<100 nm). The aim was then to immobilize streptavidin on these particles in order then to detect biotin-labelled proteins. The aim was for the nanoparticles to be sufficiently small that they can be employed in microarrays. A highly monodisperse size distribution and the greatest possible fluorescence should be the aim of the particle synthesis.

Streptavidin labelled with fluorescent dyes already exists, but the resultant measurement signal is very small. By contrast, a nanoparticle (diameter <100 nm) can contain a large number of fluorescent dye molecules. A highly sensitive method for protein detection would thus be available. The biotin/|streptavidin system is particularly suitable for such determinations since it has been investigated very well and the affinity between biotin (vitamin H) and streptavidin is very high. The binding between biotin and streptavidin is very strong, meaning that the binding partners do not dissociate before the measurement is complete.

Fluorescent melamine-formaldehyde particles are, as has already been mentioned, used as support materials in diagnostics and are also marketed by a number of companies, for example by Sigma-Aldrich or MicroParticles. The MF particles on offer are in the range from 1 to 15 μm. MF particles having a particle diameter of significantly smaller than 1 μm are not known to date. For the range 0.1 to 3 μm, predominantly polystyrene-based fluorescent microspheres are known (for example from Merck Estapor), but these have the disadvantage that the smallest diameters of about 0.1 μm are not monodisperse.

However, melamine-based nanoparticles have some other advantages over polystyrene-based materials. They have, for example, a higher density (1.51 g/cm³), are very stable, can be stored for an unlimited time, can be re-suspended in water, are heat-stable to 200° C. and are in monodisperse form in water. In addition, fluorescent dyes can easily be incorporated into the MF particles (see WO 03/074614). They cannot be washed out. It is thought that dyes are not covalently bonded in the particles, such as, for example, in silica particles, but are only embedded therein.

DD-224 602 discloses a process for the production of monodisperse melamine-formaldehyde latices having particle sizes in the range from 0.1 to 15 μm, where the MF particles are produced by polycondensation of melamine and formaldehyde in aqueous medium with low-concentration formic acid (0.87%). Furthermore, the functionalisation of these latices and the incorporation of dyes, in particular fluorescent dyes, is described.

The functionalisation of MF particles can be carried out by two routes. Firstly, a hydrophilic substance having the desired functionality can be added during the polycondensation. This is integrated into the particles. Functional groups will be located on the surface, but some of this substance will be included in the interior of the particles. It is difficult in this type of functionalisation to control the coverage of the surface.

Secondly, the particles can be functionalized subsequently. Reactive groups are located on the surface of the melamine resin particles. These can be detected, for example, by modifying the surface by means of a long-chain carboxylic acid chloride, so that the particles are subsequently hydrophobic.

Surprisingly, it has now been possible to develop nanoscale MF particles having a particle diameter of 10 to 95 nm which comprise one or more hydrophilic organometallic or organic fluorescent dyes. The MF particles preferably have a diameter of 30 to 50 nm and are monodisperse.

Melamine resins are based on the 1,3,5-triamino-2,4,6-triazine skeleton. A methylolated melamine can be prepared using 2-6 mol of formaldehyde per mole of melamine. Since the methylol melamines have low stability in water, they are etherified in commercially available products. Melamines etherified with methanol are readily water-soluble, whereas those etherified with butanol are readily soluble in organic solvents.

The commercially available melamine-formaldehyde resin employed here (Madurit SMW 818 from Surface Specialties) is a 75% aqueous solution. The melamine:formaldehyde molar ratio is in the range from 1:2.8 to 1:3.8, and 45-55% of all methylol groups are methanol-etherified.

The production of monodisperse melamine particles is described, for example, in DD-224 602. As already mentioned, they can easily be functionalized during the polycondensation, with the polycondensation taking place in acidic medium. The size of the particles can be influenced by the nature and concentration of the methylol melamine employed, the pH and the temperature during addition of the acid. Elevated temperatures, low pH, melamine resin containing a large number of methylol groups and low resin concentration each shift the reaction towards smaller particles.

Polycondensation in acidic medium is also described in DE 4019844, where the acid catalyst used is sulfuric acid.

The nanoscale MF particles according to the invention are produced by stirring up MF resin in a sufficiently large amount of water at temperatures in the range between 60 and 80° C. and subsequently adding 98 to 100% formic acid so that particles having a diameter of between 10 and 95 nm are formed. Formic acid has proven to be a suitable condensation initiator since the results are reproducible therewith. With hydrochloric acid—which has a significantly higher pKA value—by contrast, the results are not reproducible. 15 to 20% by weight of concentrated formic acid (i.e. 98 to 100%) are preferably added.

In order to obtain fluorescent nanoscale MF particles, hydrophilic organometallic or organic fluorescent dyes are added to the MF particles before the reaction with concentrated formic acid.

The dyes must not be modified in advance since they are embedded in the particles, but are not covalently bonded into them. In order to be integrated into the MF particles, the dyes must merely be hydrophilic.

Hydrophilic organic dyes which can be employed are, for example, fluorescent dyes, such as, for example, rhodamine B and rhodamine derivatives (red), fluorescein and fluorescein derivatives (yellow), aminomethylcoumarine and coumarine derivatives (blue). Organometallic dyes which can be employed are, for example, terbium³⁺ Tiron complex (green) and europium trisdipicolinate (red).

Preference is given to the use of 8-hydroxy-1,3,6-pyrenetrisulfonic acid trisodium salt, in which case the particles then fluoresce in dark green.

The smaller the particles, the larger their specific surface area. If this surface area is not densely covered with functional groups, a large amount of streptavidin can in principle also be bound by small MF particles.

During the coupling of streptavidin to the nanoscale MF particles, it is important that the biotin binding capacity of streptavidin is maintained. Streptavidin can be bound to particles by a one-step reaction or a two-step reaction (see G. T. Hermanson et al., Immobilised Affinity ligand Techniques (1992)).

EDC (N-(3-dimethylaminopropyl)-N′-ethylcarbodiimide) is a conventional reagent for coupling proteins to other molecules. In the one-step reaction, EDC reacts with a carboxyl group to give an ester intermediate, which is able to react with a primary amine. With NHS (N-hydroxylsuccinimide), a more stable ester intermediate is formed in the two-step reaction and is subsequently reacted with the protein.

EDC is able to react both with a carboxyl group on an MF particle and with one on streptavidin. Theoretically, it is therefore also possible for two or more streptavidin molecules to be crosslinked with one another, and these would then no longer be available for reaction with the MF particle surface. In order to prevent this possible crosslinking, a two-step reaction can be carried out, as already mentioned above. In this case, firstly the nanoscale MF particles are reacted with EDC and NHS, and the excess reagents are washed out, meaning that EDC cannot react with streptavidin. Only then is the streptavidin solution added. Since only the particle surface is activated, the streptavidin molecules can also only react with the latter.

As an aside, it should be noted that there is virtually no difference between the reaction with EDC (one-step reaction) and that with EDC/NHS (two-step reaction). Using both methods, approximately the same amount of streptavidin is bound to the surface of the nanoscale MF particles.

In order to check whether streptavidin is immobilised on the particles, fluorescein/biotin is added to the particle suspension. The unbound fluorescein/biotin can be determined quantitatively in a fluorescence spectrometer.

The nanoscale, preferably monodisperse and fluorescent MF particles can be used as support material for the preparation of biomarkers, ink-jet inks, as fluorescent labels in and on articles of use of all types (for example documents and/or banknotes) and/or as adsorption material for chromatographic separations, where for chromatographic applications, non-fluorescent MF particles are also acceptable.

The following examples are intended to explain the present invention in greater detail without restricting it.

### EXAMPLE 1

Colourless Nanoscale Melamine-Formaldehyde Particles

450 g of water are warmed to 70° C. The melamine-formaldehyde resin (15 g of Madurit SMW818) stirred up in 50 g of water is added at 70° C. The solution remains clear. When the temperature has risen to 70° C. again, 2 ml of 98-100% formic acid are added, and the mixture is stirred at this temperature for a further 20 min. Virtually no turbidity is evident, but the Tyndall effect known to the person skilled in the art can readily be observed with the aid of a flash light.

The particles obtained after purification by ultrafiltration (30 kDalton membrane) have an average diameter of about 40 nm, measured in the scanning electron microscope.

### EXAMPLE 2

Fluorescent Nanoscale Melamine-Formaldehyde Particles

450 g of water and 25 mg of 8-hydroxy-1,3,6-pyrenetrisulfonic acid sodium salt are warmed to 70° C. The resin (15 g of Madurit SMW818) stirred up in 50 g of water is added at 70° C. The solution remains clear. When the temperature has risen to 70° C. again, 2 ml of 98-100% formic acid are added, and the mixture is stirred at this temperature for a further 20 min. After about 1 min, the batch becomes slightly turbid. The particles obtained after purification by ultrafiltration (30 kDalton membrane) have a diameter of about 46 nm measured in the scanning electron microscope.

### EXAMPLE 3

Conjugation of the Nanoparticles with Streptavidin via EDC Solution (One-Step Reaction)

1 ml of a suspension comprising 10% by weight of melamine particles (=100 mg of solid) are weighed out into an Eppendorf cap, suspended in 1 ml of 50 mM MES buffer (2-morpholinoethanesulfonic acid (Merck) pH 5.5) and subsequently centrifuged off in an ultracentrifuge at 60,000 min⁻¹. The supernatant is discarded, and the washing operation is repeated. The particles are then resuspended in 1 ml of protein solution (10 mg/ml of streptavidin in MES buffer) and transferred into a sealable glass tube. The particles are kept in suspension for 30 minutes by rolling. 100 μl of EDC solution (10 mg/ml of N-(3-dimethylaminopropyl)-N′-ethylcarbodiimide (Merck) in distilled water or MES buffer, prepared immediately before use) are then added.

The particles are kept in suspension overnight at room temperature. During this time, the EDC reacts with the carboxyl groups on the particle surface, and the streptavidin reacts with the conjugate formed. The sample is re-centrifuged, and the supernatant is discarded. After addition of 1 ml of ethanolamine solution (1 M ethanolamine (Merck), pH 9.0, 25 mM tetrasodium diphosphate decahydrate (Merck)), the sample is rolled for a further hour before being re-centrifuged. Ethanolamine reacts with the residual activated esters to give amides. The mixture is then washed three times with 1 ml of PBS buffer (10 mM NaH2PO4 (Merck), pH 7.5, 150 mM NaCl (Merck)) each time. The particles are resuspended in PBS buffer for a final time and can be stored in the refrigerator at 4° C.

### EXAMPLE 4

Conjugation of the Nanoparticles with Streptavidin via EDC/NHS (Two-Step Reaction)

1 ml of a suspension comprising 10% by weight of melamine particles (=100 mg of solid) are weighed out into an Eppendorf cap, suspended in 1 ml of 50 mM MES buffer (2-morpholinoethanesulfonic acid (Merck) pH 5.5) and subsequently centrifuged off in an ultracentrifuge at 60,000 min⁻¹. The supernatant is discarded, and the washing operation is repeated. The particles are then resuspended in 1 ml of MES buffer and transferred into a sealable glass tube. 100 μl of EDC/NHS solution (100 mg/ml of EDC, 16 mg/ml of N-hydroxysuccinimide (Merck) in MES buffer) are added. The particles are kept in suspension for 1 hour at room temperature by rolling, during which the NHS is coupled to the carboxyl groups on the particle surface. The sample is centrifuged again, and the supernatant is discarded. The mixture is washed again with 1 ml of MES buffer.

The particles are resuspended in 1 ml of protein solution and rolled overnight at room temperature. The countersamples are resuspended in 1 ml of MES buffer (no addition of EDC/NHS and protein solution) and rolled overnight. The sample is centrifuged, and, after addition of 1 ml of ethanolamine solution, the sample is rolled for a further hour before being re-centrifuged. Ethanolamine reacts with the residual activated esters to give amides. The mixture is then washed three times with 1 ml of PBS buffer each time. The particles are then resuspended again in PBS buffer and can be stored in the refrigerator at 4° C.

### EXAMPLE 5

Detection of the Binding of Streptavidin to the Nanoparticles via Fluorescein/Biotin

In order to check whether streptavidin is immobilised on the particles, fluorescein/biotin is added to the particle suspension. One streptavidin molecule can bind 4 biotin molecules. Since a defined amount of biotin (M=44.31 g/mol) is added to the particles reacted with streptavidin, the amount of bound streptavidin can be calculated therefrom up to this factor 4.

10 μl of suspension (this corresponds to 1 mg of particles) from each sample are pipetted into a fresh Eppendorf cap. 200 μl of biotin/fluorescein solution (1 gmol/μl in PBS buffer) are then added to each of the samples. They are shaken at room temperature for 15 minutes and subsequently centrifuged. The samples are now transferred onto a microtitre plate in order to be able to measure them in the fluorescence spectrometer. To this end, 125 μl of PBS buffer are initially introduced into each well, and 75 μl of the supernatant from the Eppendorf cap are then added. A double determination is carried out for each sample. 200 μl of PBS buffer are measured as the blank value, 75 μl of the biotin/fluorescein solution in 125 μl of PBS buffer as the maximum value. The unbound biotin is thus determined. The amount of bound biotin can be calculated from this value since it is known through the maximum value how much biotin was added to the sample.

In order to investigate the magnitude of the background binding of biotin, the biotin-coated particles are washed again with 200 μl of 1 M NaCl after the measurement and centrifuged. Twice 75 μl of the supernatant are measured again in 125 μl of PBS buffer. This value must be subtracted from the value of bound biotin in the evaluation. The biotin which can be redissolved using 1 M NaCl was only adsorbed nonspecifically at the surface.

1. Nanoscale melamine-formaldehyde particles (MF particles), characterised in that they have a particle diameter of 10 to 95 nm.

2. Nanoscale MF particles according to claim 1, characterised in that they have a particle diameter of 30 to 50 nm and are monodisperse.

3. Nanoscale MF particles according to claim 1, characterised in that they comprise one or more hydrophilic organometallic or organic fluorescent dyes.

4. Nanoscale MF particles according to claim 3, characterised in that the hydrophilic fluorescent dye present is 8-hydroxy-1,3,6-pyrenetrisulfonic acid sodium salt.

5. Nanoscale MF particles according to claim 1, characterised in that they are conjugated with streptavidin.

6. Process for the production of nanoscale MF particles by reaction of formic acid with melamine-formaldehyde resin in aqueous medium, characterised in that melamine-formaldehyde resin is stirred up in a sufficiently large amount of water at temperatures in the range between 60 and 80° C., and 98 to 100% formic acid is subsequently added, so that particles having a diameter of between 10 and 95 nm are formed.

7. Process according to claim 6, characterised in that monodisperse MF particles having a diameter of between 30 and 50 nm are formed.

8. Process according to claim 6, characterised in that 15 to 20% by weight of concentrated formic acid are added.

9. Process according to claim 6, characterised in that hydrophilic organometallic or organic fluorescent dyes are added to the MF particles before the reaction with formic acid.

10. Process according to claim 9, characterised in that the hydrophilic fluorescent dye employed is 8-hydroxy-1,3,6-pyrenetrisulfonic acid trisodium salt.

11. Process according to claim 6, characterised in that streptavidin is coupled to the surface of the nanoscale MF particles via a one-step reaction by activation by means of N-(3-dimethylaminopropyl)-N′-ethylcarbodiimide).

12. Process according to claim 6, characterised in that streptavidin is coupled to the surface of the nanoscale MF particles via a two-step reaction by activation by means of N-(3-dimethylaminopropyl)-N′-ethylcarbodiimide) and N-hydroxylsuccinimide.

13. Biomarkers, ink-jet inks, fluorescent labels in and on articles of use, such as documents and/or banknotes, and/or adsorption material for chromatographic separations, comprising nanoscale MF particles according to claim 1.
